(19) United States
(12) Patent Application Publication
(10) Pub. No.: US 2022/0397033 A1
(43) Pub. Date: Dec. 15, 2022

(54) Guided-Wave Powered Wireless Sensors

(71) Applicant: The Regents of the University of California, Oakland, CA (US)

(72) Inventor: Aydin Babakhani, Los Angeles, CA (US)

(73) Assignee: The Regents of the University of California, Oakland, CA (US)

(21) Appl. No.: 17/758,114

(22) PCT Filed: Dec. 28, 2020
(86) PCT No.: PCT/US20/67180

§ 371 Date: Jun. 28, 2022

Related U.S. Application Data
(60) Provisional application No. 62/955,290, filed on Dec. 30, 2019.

(51) Int. Cl. E21B 47/135; G01M 3/18

(52) U.S. Cl. CPC E21B 47/135; G01M 3/18

(57) ABSTRACT

Systems and methods for transmitting power to wirelessly powered sensors using a pipeline as a circular waveguide are disclosed. In an embodiment, a transmitter transmits electromagnetic waves to at least one wirelessly powered sensor positioned along the pipeline, wherein the pipeline is used as a waveguide to transmit the electromagnetic waves using a particular waveguide mode form of electromagnetic radiation, where the at least one wirelessly powered sensor is configured to be operated without a battery and to be powered by the electromagnetic waves emitted by the electromagnetic transmitter and senses at least one characteristic of the pipeline.

### CROSS REFERENCE TO RELATED APPLICATIONS

The current application is a national stage of PCT Patent Application No. PCT/US2020/067180 entitled “Guided-Wave Powered Wireless Sensors” filed Dec. 28, 2020, which claims the benefit of U.S. Provisional Patent Application No. 62/955,290 entitled “Guided-Wave Powered Wireless Sensors” filed Dec. 30, 2019, the disclosures of which are incorporated herein by reference in their entirety.

### STATEMENT OF FEDERALLY SPONSORED RESEARCH

This invention was made with government support under Grant Number DE-FE0031569, awarded by the U.S. Department of Energy. The government has certain rights in the invention.

### FIELD OF THE INVENTION

The present invention generally relates to guided-wave powered wireless sensors and in particular, use of an oil/gas cylindrical pipeline as a waveguide to propagate wireless power to and communicate with embedded wirelessly powered sensors embedded along the pipeline for pipeline monitoring and leak detection.

### BACKGROUND

It is believed that over 100 million barrels of oil are consumed per day worldwide and that, on average, about 40% of the oil being consumed is transported via pipeline. Monitoring of these and other types of oil/gas pipelines for leaks and other conditions has been challenging as oftentimes these pipelines are buried underground in inaccessible locations as well as stretching for thousands of miles across land. Because of the volume of oil being transported daily, it is vital to facilitate the monitoring of such pipelines in order to detect leaks and/or other conditions.

Existing monitoring techniques include conducting manual visual inspections, if possible on above ground pipelines, for example using drones to view the pipelines. Other techniques include installing or running cables, such as fiber optics cables, along the pipelines that can monitor the state of the pipeline. However, visual inspections are both infrequent and inefficient while running fiber optics cables can be prohibitively expensive to install over the hundreds if not thousands of miles of oil/gas pipelines that require monitoring.

### BRIEF SUMMARY OF THE INVENTION

Systems and method for using a cylindrical shape as a waveguide to propagate wireless power to and communicate with embedded wirelessly powered sensors embedded along the cylindrical are described. In an embodiment, the system includes a cylindrical shape, an electromagnetic transmitter positioned along the cylindrical shape and configured to transmit electromagnetic waves to at least one wirelessly powered sensor positioned along the cylindrical shape, where the cylindrical shape is used as a waveguide to transmit the electromagnetic waves using a particular waveguide mode, where the at least one wirelessly powered sensor is configured to be operated without a battery and to be powered by the electromagnetic waves emitted by the electromagnetic transmitter, where the at least one wirelessly powered sensor senses at least one characteristic related to the cylindrical shape.

In a further embodiment, the electromagnetic transmitter transmits the electromagnetic waves along an outer surface of the cylindrical shape to the at least one wirelessly powered sensor.

In still a further embodiment, the electromagnetic transmitter transmits the electromagnetic waves along an inner surface of the cylindrical shape to the at least one wirelessly powered sensor.

In still a further embodiment again, the electromagnetic transmitter transmits the electromagnetic waves using a mode selected from the group consisting of a transverse electromagnetic mode (TEM), a transverse magnetic mode (TM), and a transverse electric mode (TE).

In still a further embodiment again, the cylindrical shape is a pipeline used to transport a natural resource including at least one of a fluid and a gas.

In still a further embodiment again, the fluid comprises a hydrocarbon liquid.

In yet still a further embodiment again, the cylindrical shape is used as a circular waveguide.

In yet still a further embodiment again, further comprising a controller configured to communicate with the at least one wirelessly powered sensor.

In yet still a further embodiment again, the at least one wirelessly powered sensor transmits data to the controller using the surface of the cylindrical shape as a waveguide.

In yet still a further embodiment again, the cylindrical shape is a pipeline buried beneath the earth's surface.

In yet still a further embodiment again, the at least one wirelessly powered sensor comprises a plurality of wirelessly powered sensors embedded at different locations along the cylindrical shape.

In yet still a further embodiment again, the cylindrical shape is a pipeline and the at least one wirelessly powered sensor is used to monitor at least one characteristic selected from the group consisting of an integrity of the pipeline, detection of corrosion and cracks along the pipeline, detection of changes in pH, detection of leaks, and detection of gases.

In yet still a further embodiment again, the system is further configured to provide a notification upon detection of a particular event related to the cylindrical shape based on data from the at least one wirelessly powered sensor.

In yet still a further embodiment again, the at least one wirelessly powered sensor is a wireless sensor that is capable of measuring at least one state of the cylindrical shape selected from the group consisting of a temperature, a flow rate, and a pressure.

In another embodiment, a method of transmitting power using a circular waveguide, includes: transmitting, using an electromagnetic transmitter positioned along a cylindrical shape, electromagnetic waves to at least one wirelessly powered sensor positioned along the cylindrical shape, wherein the cylindrical shape is used as a waveguide to transmit the electromagnetic waves using a particular waveguide mode form of electromagnetic radiation; wherein the at least one wirelessly powered sensor is configured to be operated without a battery and to be powered by the electromagnetic waves emitted by the electromagnetic transmitter; and sensing, using the at least one wirelessly powered sensor, at least one characteristic related to the cylindrical shape.

In a further embodiment, the electromagnetic waves are transmitted along an outer surface of the cylindrical shape to the at least one wirelessly powered sensor.

In yet a further embodiment again, the electromagnetic waves are transmitted along an inner surface of the cylindrical shape to the at least one wirelessly powered sensor.

In yet a further embodiment again, the electromagnetic waves are transmitted using a mode selected from the group consisting of a transverse electromagnetic mode (TEM), a transverse magnetic mode (TM), and a transverse electric mode (TE).

In yet a further embodiment again the cylindrical shape is a pipeline used to transport a natural resource including at least one of a fluid and a gas.

In yet a further embodiment again further comprising providing a notification upon detecting a particular event related to the cylindrical shape based on data from the at least one wirelessly powered sensor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1A illustrates a cylindrical shape pipeline with a monitoring station and several sensors positioned along the pipeline to monitor various characteristics related to the pipeline in accordance with an embodiment of the invention.

FIG. 1B illustrates a cylindrical pipeline with a hydrocarbon liquid flowing thru the pipeline in accordance with an embodiment of the invention.

FIG. 2 illustrates a cylindrical waveguide with a power source that initiates the transmission of a wave from the top circle, and the bottom circle illustrates how much of the wave arrives at the bottom in accordance with an embodiment of the invention.

FIG. 3 illustrates the Z parameters of a waveguide in accordance with an embodiment of the invention.

FIG. 4 illustrates several different Z parameters for a terminal at different frequencies in accordance with an embodiment of the invention.

FIG. 5 illustrates an experimental setup for analyzing waves transmitted on a surface of a cylindrical tube from a power source to a receiver in accordance with an embodiment of the invention.

FIG. 6 illustrates a magnitude of an important S-parameter metric, S21, which shows how much a wave can propagate from a transmitter and be captured at a receiver as a function of frequency in accordance with an embodiment of the invention.

FIG. 7 illustrates an example of a wirelessly powered micro-sensor chip in accordance with an embodiment of the invention

FIG. 8 illustrates an architecture of a wirelessly powered micro-sensor in accordance with an embodiment of the invention

FIG. 9 illustrates a 5-meter distance in a lossy reservoir, for example including the effect of soil to determine how much power gets captured by a receiver in accordance with an embodiment of the invention.

FIG. 10 provides various measurement results describing how much power gets coupled from a power transmitter to a receiver in accordance with an embodiment of the invention.

FIG. 11 illustrates an example of S-parameters vs. frequency from a first mode of transmitter (TX) to first mode of receiver (RX) in accordance with an embodiment of the invention.

FIG. 12 an example graph for an S-parameter vs. frequency between two different transmission modes and how much coupling occurs from the transmitter to the receiver in accordance with an embodiment of the invention.

FIG. 13A to 13H illustrate the different electric field distributions for various different transmission modes and the coupling between the transmitter and the receiver for the different modes in accordance with an embodiment of the invention.

FIG. 14 illustrates a graph comparing the S-parameter for low-loss mode transfers in accordance with an embodiment of the invention.

FIG. 15 illustrates a pipeline transmission line geometry, where b can be set to infinity in accordance with an embodiment of the invention.

FIG. 16a-16d illustrate an experimental setup for analyzing a cylindrical surface waveguide in accordance with an embodiment of the invention.

### DETAILED DESCRIPTION OF THE DRAWINGS

Turning now to the drawings, systems and methods for using guided waves on a waveguide to provide wireless power and to communicate with wirelessly powered micro-sensors in accordance with embodiments of the invention are illustrated. In an embodiment, the waveguide can be a mostly cylindrical pipeline, such as an oil or gas pipeline, that can be used to propagate wireless power to one or more wirelessly powered micro-sensors positioned along the pipeline. In many embodiments, numerous sensing chips can be embedded in a cement material outside a wellbore casing in oil/gas wells in order to monitor the integrity of the wellbores, detection corrosion and/or cracks, changes in pH, among various other properties of the wellbore. In many embodiments, the embedded chips can sense events, such as leaks in the pipe, and produce a notification such as an alarm in order to help prevent a catastrophic event from happening. In many embodiments, a series of wirelessly powered chips can be embedded along a cylindrical pipeline at certain spaced distances and power can be transferred to these chips wirelessly from a wireless power source. In many embodiments, the external surface of the cylindrical pipeline can be used to support traveling of guided modes that can be used to keep the wireless energy around the pipeline. In many embodiments, the external surface of the cylindrical pipeline can provide a wireless channel with low attenuation that can be used to power the sensing microchips and to communicate with the microchips over long distances. Described in detail below are analytical, simulation and experimental results that illustrate the effectiveness of these approaches for powering and communicating with the various wireless sensors.

Accordingly, many embodiments provide for continuous, real-time and event driven monitoring of pipelines through which flow assets such as refined and natural resources. In several embodiments, the system includes a network of wirelessly powered sensors positioned along a pipeline and one or more wireless power transmitters that provide wireless power to and communicate with the wirelessly powered sensors. In many embodiments, the wirelessly powered sensors can be positioned at regular spaced intervals along the pipeline to monitor and measure various aspects of the pipeline, and provide notifications such as alarms upon the detection of an event. In many embodiments, the wireless powered sensor data can be transmitted to a monitoring station via a communication link, such as a wired or wireless transmitter.

The controllers can wirelessly acquire data related to the pipeline and communicate with the sensors, transmit the related sensor data directly or indirectly to a network external to the system. The wireless power transmitters can be positioned at a multitude of different locations along the pipeline in order to provide power to the wireless chips embedded along the pipeline. In many embodiments, the one or more wireless chips embedded along the pipeline can be a wireless hydrocarbon sensor. In many embodiments the wireless chips can be a device capable of measuring state conditions of a pipeline or that of its content such as temperature, flow rate, and pressure. In several embodiments, the wireless microchip device can be an activity monitoring or reconnaissance device such as a camera, a microphone, a motion detector, a light detector, and a broadband RF signal scanner.

In many embodiments, the cylindrical pipeline is a hydrocarbon pipeline and a tubing is disposed within the pipeline to transport the hydrocarbon liquid. Metal loss due to corrosion may occur to the interior of the tubing. In many embodiments, the wireless micro-sensors position along the pipeline can monitor and detect various properties of the pipeline, including detecting leaks, checking the pressure of the liquid within the pipeline, among various other sensing capabilities.

Many embodiments use a particular transverse mode form of electromagnetic radiation to provide power and/or communicate with the wireless sensors. A transverse mode is a particular electromagnetic field pattern of the radiation in the plane perpendicular (i.e., transverse) to the radiation's propagation direction. In many embodiments, the system can provide for wirelessly powering embedded sensors on a cylindrical pipeline using transverse electromagnetic mode (TEM), TM (transverse magnetic), and/or TE (transverse electric) mode radar waves. In many embodiments, the lowest loss mode is a TEM mode where the E-field is radial. In many embodiments, the external surface can also support TE and TM modes, however, these may have higher propagation loss.

In many embodiments, the wave propagation modes can include the fundamental transverse electromagnetic mode (TEM), where only small electric and/or magnetic fields extend in the direction of propagation, and the electric and magnetic fields extend radially outwards while the guided-wave propagates along the waveguide. Waves can include a fundamental TEM mode where the fields extend radially outwards, and also include other, non-fundamental (e.g., asymmetric, higher-level, etc.) modes. While particular wave propagation modes are discussed, other wave propagation modes are likewise possible such as transverse electric (TE) and transverse magnetic (TM) modes, based on the frequencies employed, the design of the waveguide, the dimensions and composition of the cylindrical pipeline, as well as its surface characteristics, its optional insulation, the electromagnetic properties of the surrounding environment, among various other properties.

In the TEM modes, there is neither electric nor magnetic field in the direction of propagation. In TE modes, there is no electric field in the direction of propagation. These are sometimes called H modes because there is only a magnetic field along the direction of propagation (H is the conventional symbol for magnetic field). In TM modes, there is no magnetic field in the direction of propagation. These are sometimes called E modes because there is only an electric field along the direction of propagation.

In certain embodiments, the waveform can be a TM01 mode waveform having a frequency above 3 GHz or a TE01 mode waveform having a frequency above 4 GHz. Transmitting the waveform includes using the cylindrical pipeline as a waveguide. In many embodiments, the outside surface of the cylindrical tubing can be used as a waveguide. In certain embodiments, the interior tubing of the cylindrical pipeline can be used as a waveguide. In pertinent part, the pipeline can serve as the transmission medium—taking the place of a wire or single wire transmission medium. As such, electromagnetic waves propagate along the outer surface as surface waves or other guided-waves. Wireless sensors mounted along a pipeline can receive signals and/or wireless power from base station device and transmit data back to the base station and or any other device over wireless connection.

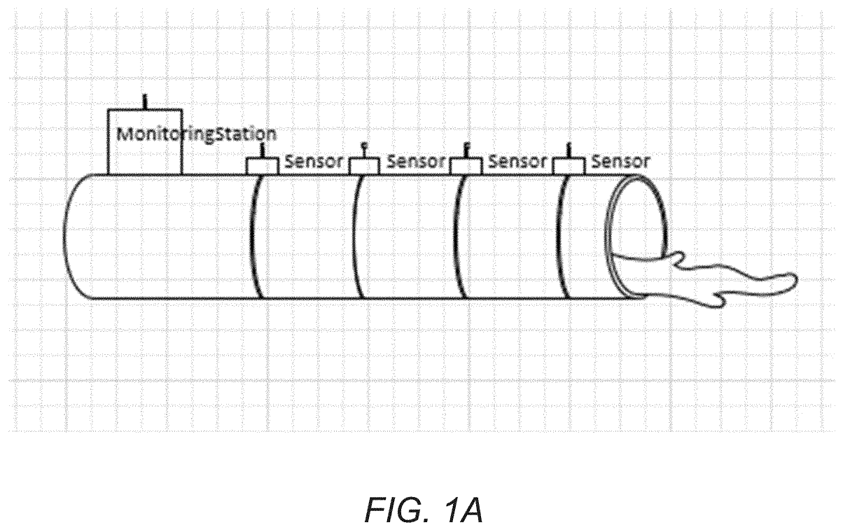

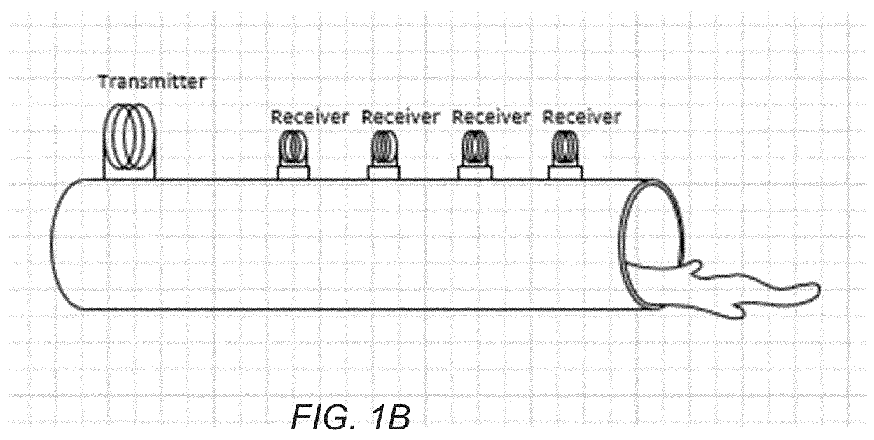

FIG. 1A illustrates a cylindrical shape pipeline with a monitoring station and several sensors positioned along the pipeline to monitor various characteristics related to the pipeline. In many embodiments, the monitoring station can wirelessly power the sensors and/or communicate data by sending and/or receiving data from the sensors. FIG. 1B illustrates a cylindrical pipeline with a hydrocarbon liquid flowing thru the pipeline. Along the outside surface is a wireless power transmitter that transmits wireless power to several wirelessly powered embedded chips embedded along the pipeline. The wireless power may use the outside surface of the cylindrical pipeline as a waveguide to propagate the waves to the receivers with low attenuation. The pipeline can be buried underground, or above ground, beneath the ocean surface, or any other location at which oil/gas pipelines may be constructed. Although FIGS. 1A and 1B illustrate a cylindrical pipeline with wireless power transmitters and wirelessly powered micro-sensors positioned on an outside surface along the pipeline, any of a variety of designs may be utilized, including positioning the sensors inside and propagating wireless power on the inside, on the bottom, sides, among various other locations as appropriate to the requirements of specific applications. Furthermore, although the discussion and figures show pipelines having a circular shape any of a variety of shapes can be utilized whereby waveguides can have a variety of shapes, sizes and configurations, including rectangular, ovals or other ellipsoid shapes, octagons, quadrilaterals or other polygons with either sharp or rounded edges, or other shapes. Described below is detailed analysis of the waveguide properties with respect to coupling of waves from a power source to a receiver.

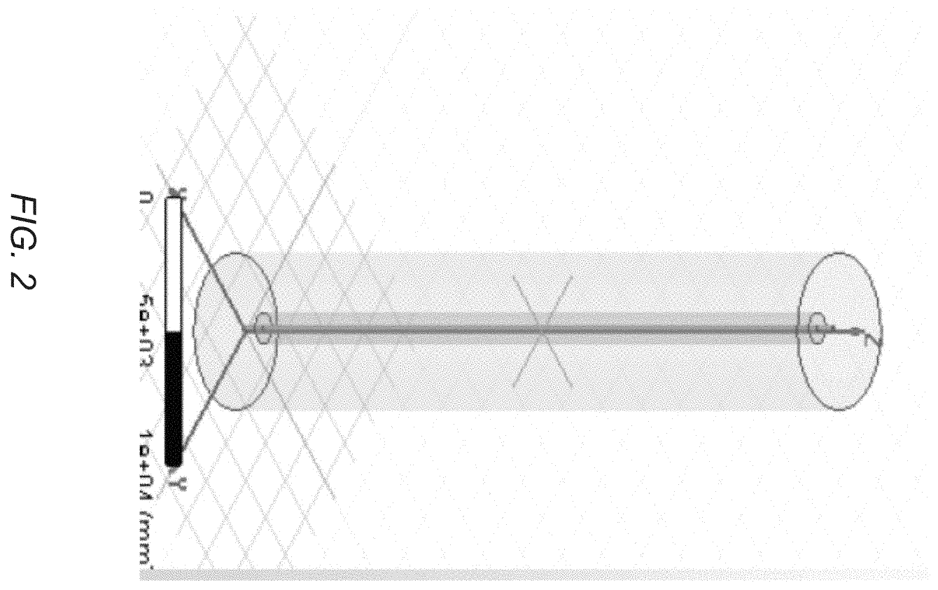

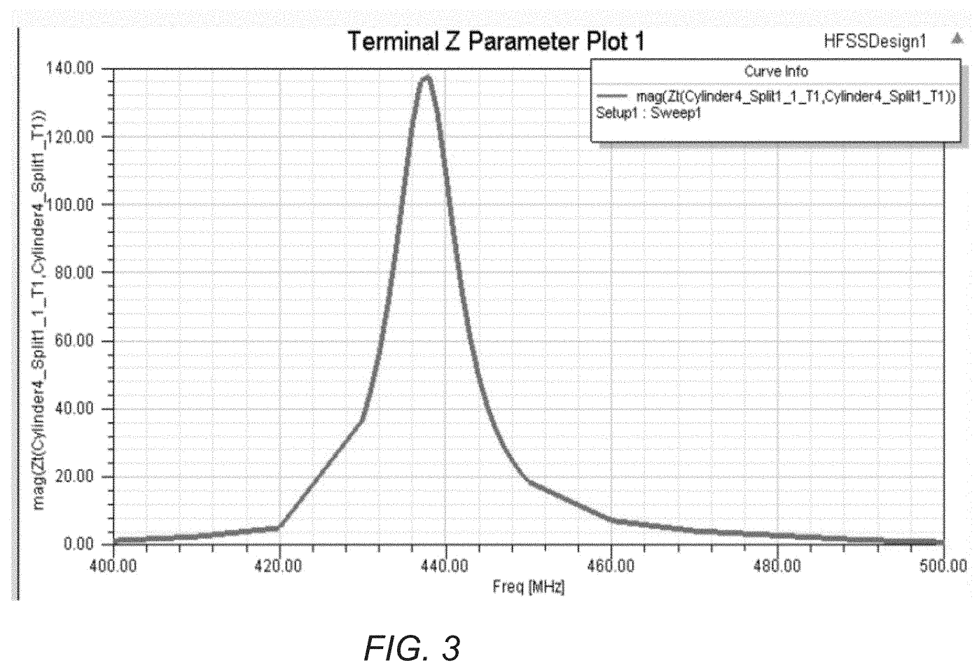

FIG. 2 illustrates a cylindrical waveguide with a power source that initiates the transmission of a wave from the top circle, and the bottom circle illustrates how much of the wave arrives at the bottom in accordance with an embodiment of the invention. This provides the scatting parameter, or S-parameter, of the waveguide, which describes the electrical behavior of linear electrical networks when undergoing various steady state stimuli by electrical signals. The S-parameter can be used to determine the impedance parameters, or Z-parameters, of the waveguide. FIG. 3 illustrates the Z parameters of a waveguide in accordance with an embodiment of the invention in accordance with an embodiment of the invention.

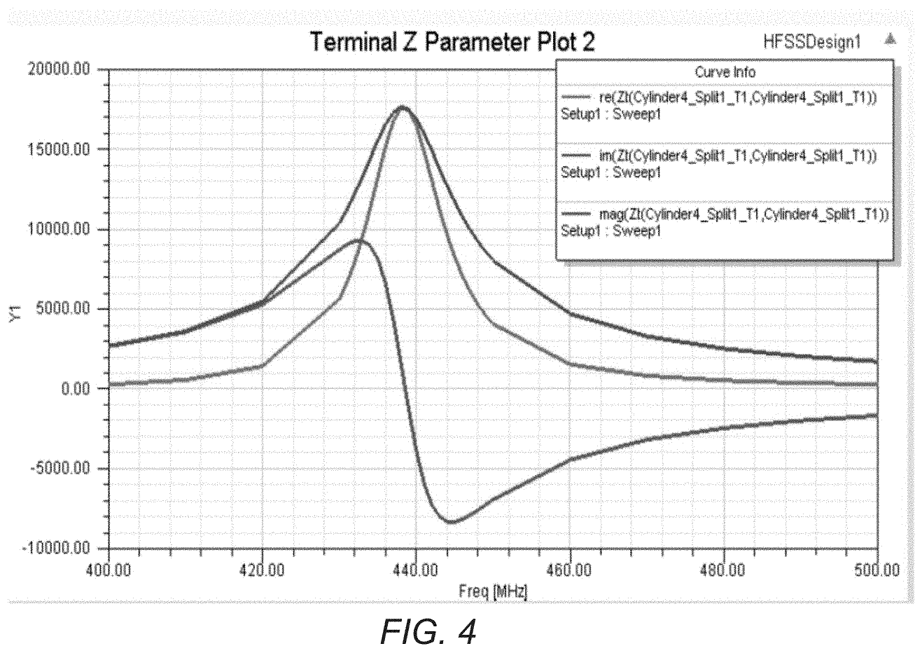

FIG. 4 illustrates several different Z parameters for a terminal at different frequencies in accordance with an embodiment of the invention.

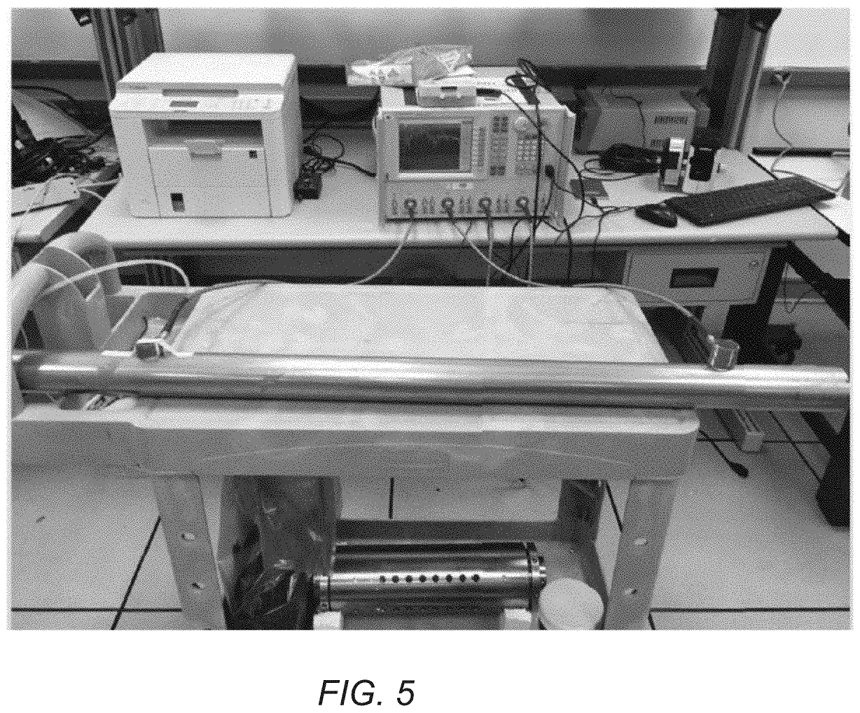

In order to analyze the properties of a waveguide, an experimental setup can be used to ascertain the coupling between a transmitted wave from a power source to a receiver. FIG. 5 illustrates an experimental setup for analyzing waves transmitted on a surface of a cylindrical tube from a power source to a receiver in accordance with an embodiment of the invention. As illustrated, the tubing is a circular tube and the power source loop and receiver loop are positioned on the outside surface of the tube. A wave can be launched with the power source wave loop and captured with a receiver loop on other side. The loops can be connected to a network analyzer that can measure how much a signal launched from source to receiver is coupled. Although FIG. 5 illustrates an example experimental setup for waveguide analysis, any of a variety of setups can be utilized as appropriate to the requirements of specific applications in accordance with embodiments of the invention.

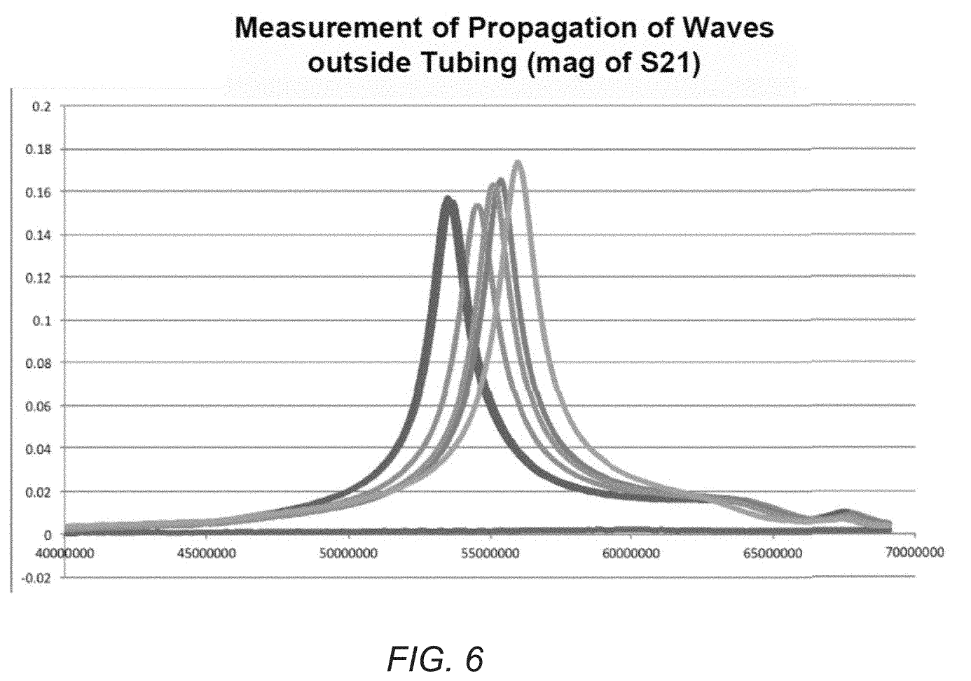

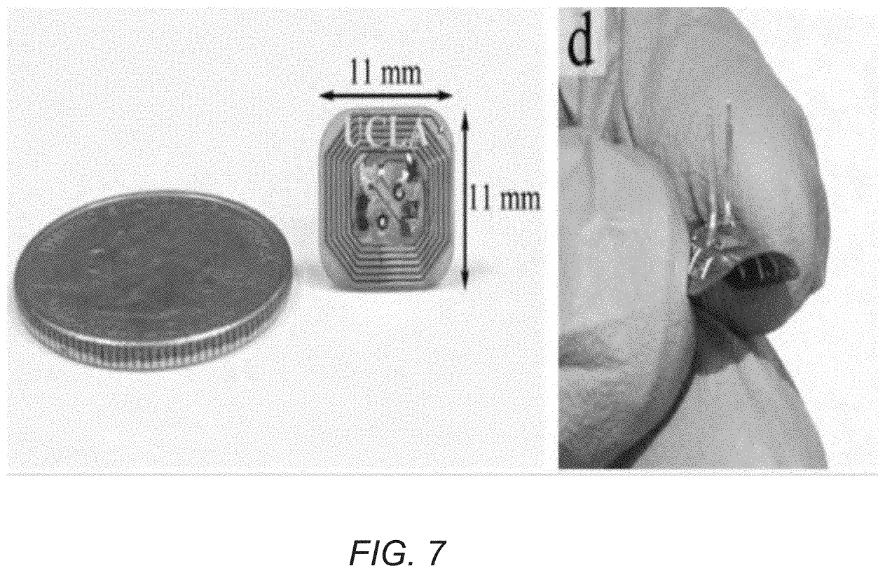

FIG. 6 illustrates a magnitude of an important S-parameter metric, S21, which shows how much a wave can propagate from a transmitter and be captured at a receiver as a function of frequency in accordance with an embodiment of the invention. In particular, different quantities of the wave can be captured based on the frequency at which a wave is radiated. As illustrated, when a wave is radiated at certain frequencies (e.g., between 50 MHz and 60 MHz), more of the wave can be captured at the receiver (e.g., from 0.02 to 0.16 of the initial wave can be captured). Accordingly, many embodiments use an optimal frequency based on the particular application in order to transmit power to and communicate with micro-sensors positioned along the waveguide. For example, an underground oil pipeline may utilize a particular frequency to account for loss attenuation from soil and rocks whereas an above ground oil pipeline may utilize a different frequency to power the micro-sensors. An example of a micro-sensor that can be positioned along a cylindrical pipeline in accordance with an embodiment of the invention is illustrated in FIG. 7.

FIG. 7 illustrates an example of a wirelessly powered micro-sensor chip in accordance with an embodiment of the invention in accordance with an embodiment of the invention. Different types of wirelessly powered micro-sensor chips can be utilized for different applications. An example of a wirelessly powered micro-sensor is described in PCT application US2019/059657, entitled “Systems and Methods for Battery-Less Wirelessly Powered Dielectric Sensors” by Babakhani et al., which is herein incorporated by reference in its entirety. The wireless dielectric sensor can be used in applications with extreme environments where it would be difficult to implement the sensor with wires, including embedded within oil and gas pipelines. A wireless power source can transmit RF power to the microchip sensors, and each microchip can transmit back a signal to a reader. In many embodiments, the microchip can be a few millimeters in size.

Furthermore, using wireless power transmission and data communication can provide for real-time monitoring of the pipeline and provide a more granular level of monitoring based on the numbers and/or distance between the micro-sensors being used. For example, a dielectric sensor may be used in a high pressure oil or gas pipeline to sense and measure flow properties, detect leaks, and measure any one of a variety of variables, including flow, temperature, volume, among various other measurements appropriate to the particular application and send this information to an external receiver Other applications include, for example, using in oil and gas reservoirs, using within cement of the oil/gas pipeline to sense whether the cement has cured, among various other applications that would benefit from providing sensing capabilities in extreme environments. Although FIG. 6 illustrates a particular wirelessly powered microchip, any of a variety of wirelessly powered microchips can be utilized as appropriate to the requirements of specific applications in accordance with embodiments of the invention.

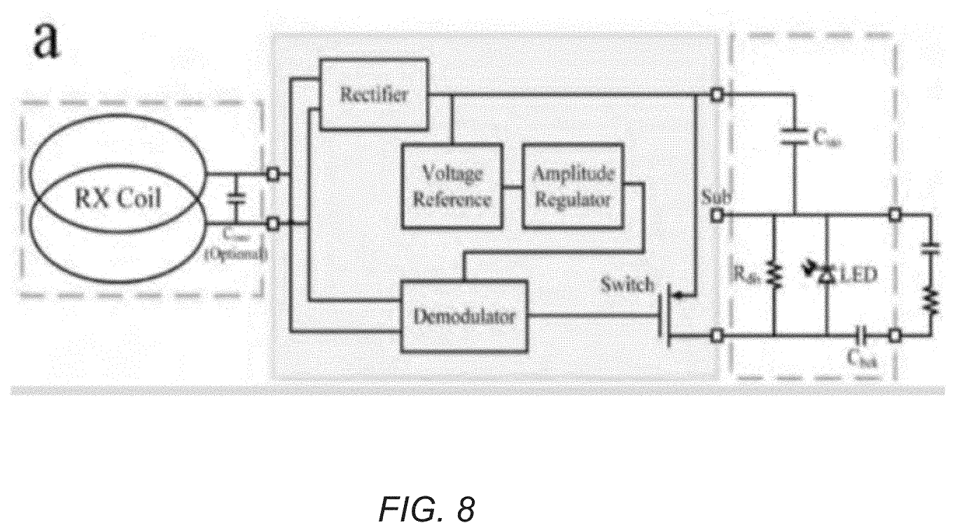

FIG. 8 illustrates an architecture of a wirelessly powered micro-sensor in accordance with an embodiment of the invention in accordance with an embodiment of the invention. Details of a wirelessly powered micro-sensor are described in PCT USUS2020/048001 entitled “Wirelessly Powered Stimulator” by Babakhani et al., which is herein incorporated by reference in its entirety. Although FIG. 8 illustrates a particular circuit architecture of a wirelessly powered micro-sensor, any of a variety of circuit architectures may be utilized as appropriate to the requirements of specific applications in accordance with embodiments of the invention.

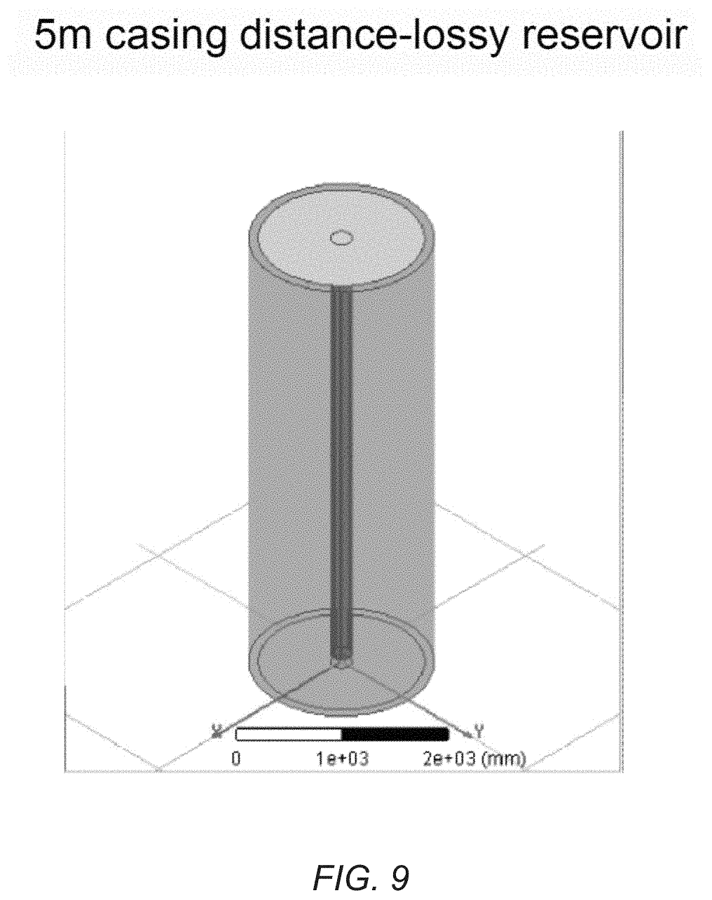

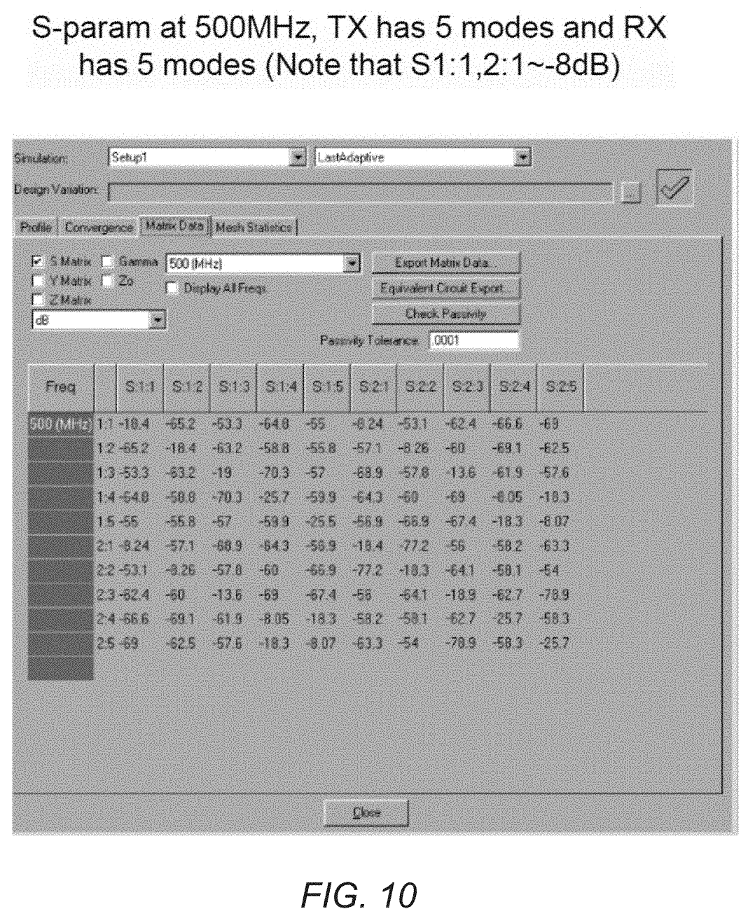

FIG. 9 illustrates a 5-meter distance in a lossy reservoir, for example including the effect of soil to determine how much power gets captured by a receiver in accordance with an embodiment of the invention. FIG. 10 provides various measurement results describing how much power gets coupled from a power transmitter to a receiver. As illustrated in FIG. 6, for example at S:2:1 at 500 MHz provides approximately a −8.24 dB illustrating that a good portion of power can get coupled to wireless receiver side even within a lossy medium.

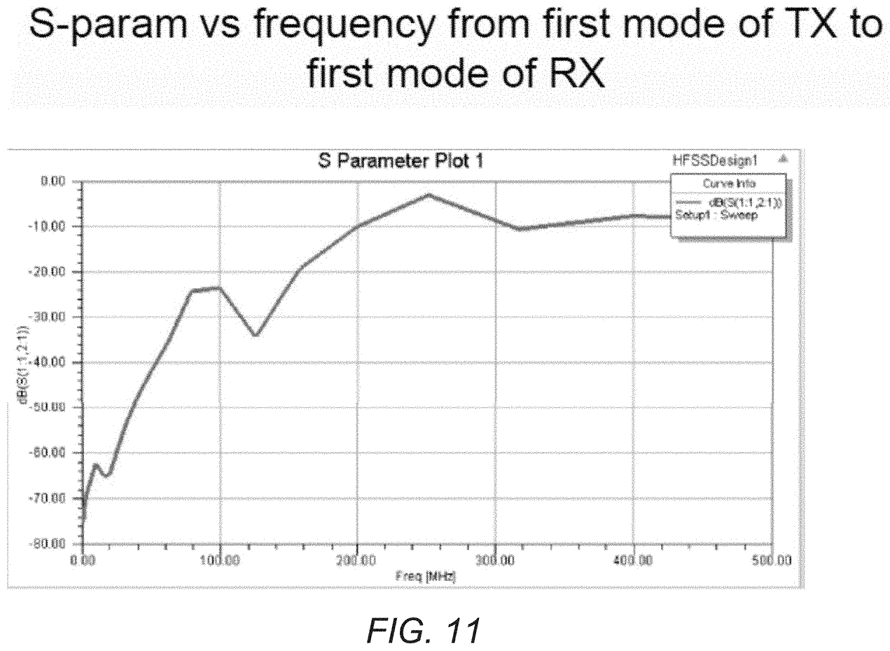

FIG. 11 illustrates an example of S-parameters vs. frequency from a first mode of transmitter (TX) to first mode of receiver (RX) in accordance with an embodiment of the invention. As illustrated, with an increase in frequency, most of the wave is coupled to the receiver. For example, from the frequency of 200 MHz to 500 MHz, about −10 dB (i.e., 10% of the wave) is coupled to the receiver. For example, if the power transmitter launches 1 kilowatt, than 100 watts can be obtained at a receiver over a distance of 5 meters, which can be sufficient power for most micro-sensors that may need to be utilized. Furthermore, higher frequencies can provide a high frequency bandpass filter response, whereby at a high frequency, a waveguide can operate as a perfect response, and whereby a circular pipeline waveguide can more easily hold a wave around it over a longer distance.

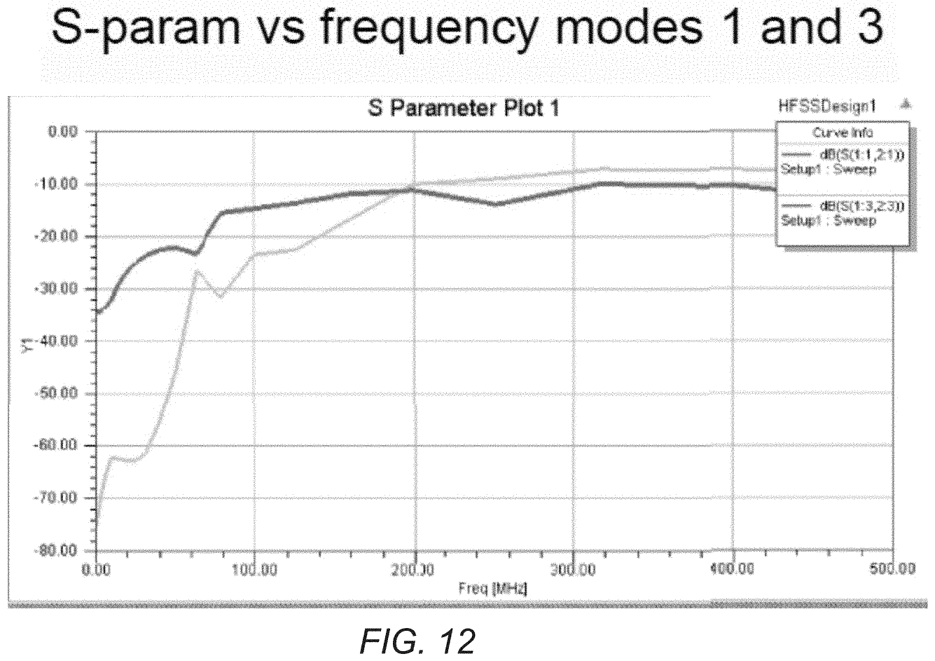

FIG. 12 an example graph for an S-parameter vs. frequency between two different transmission modes and how much coupling occurs from the transmitter to the receiver in accordance with an embodiment of the invention.

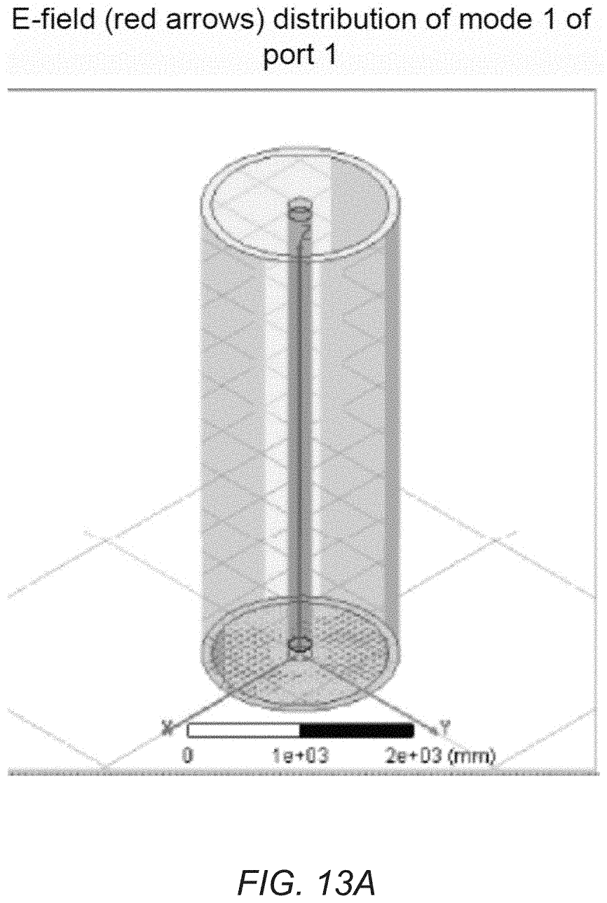

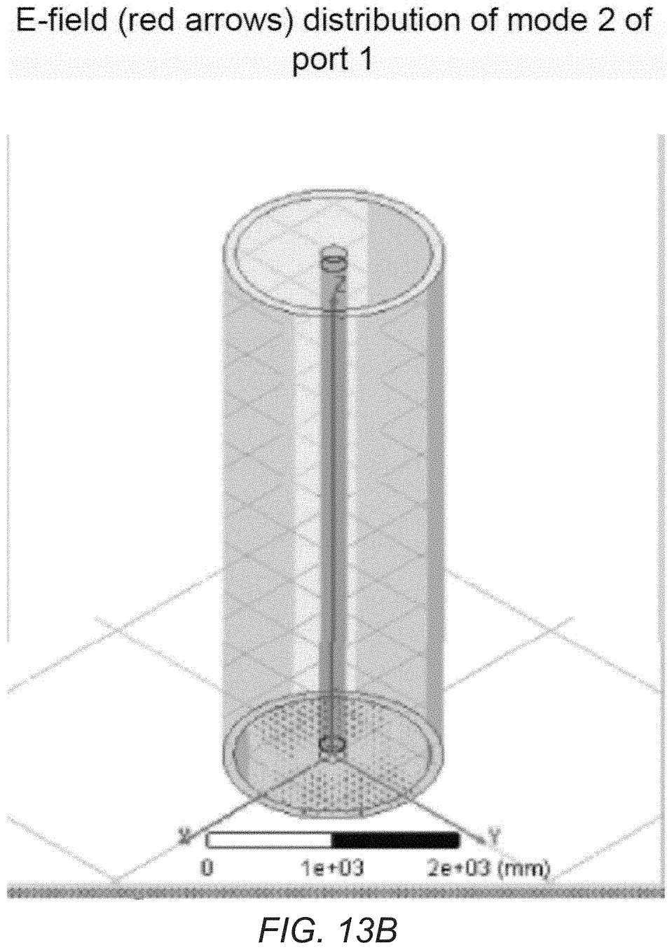

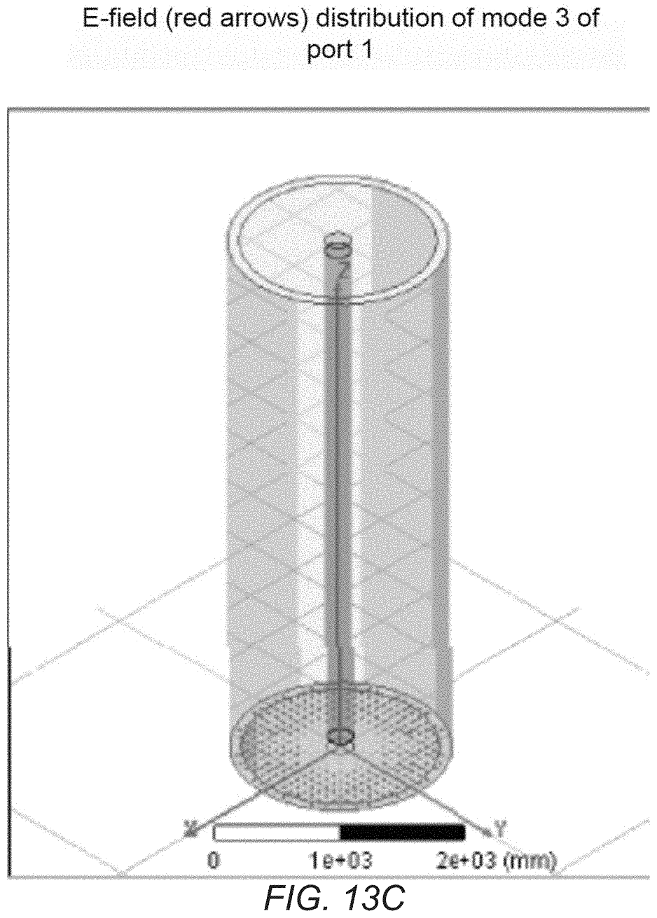

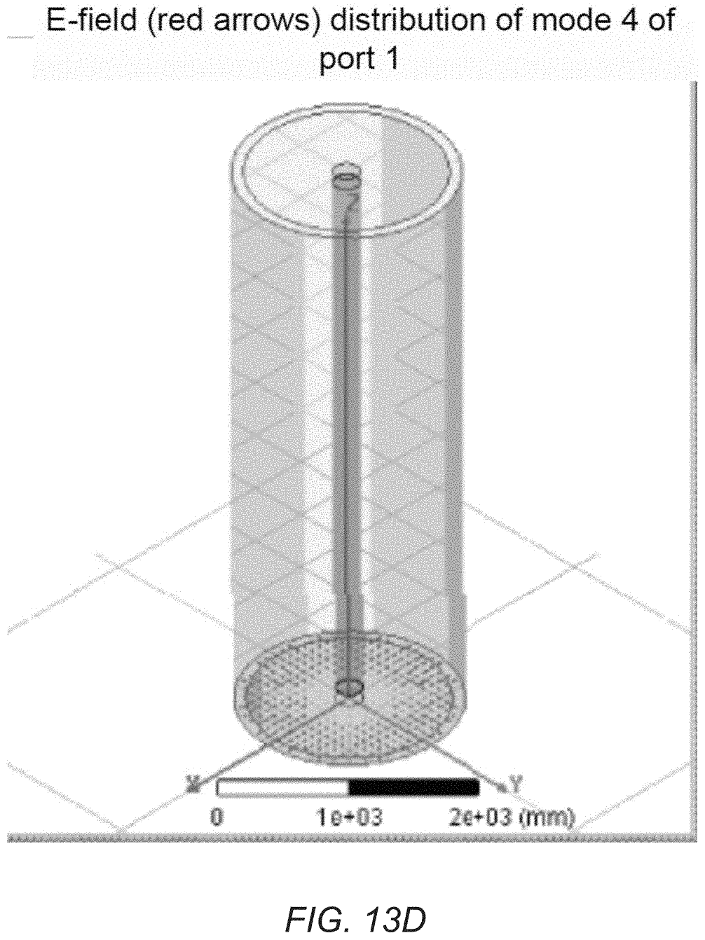

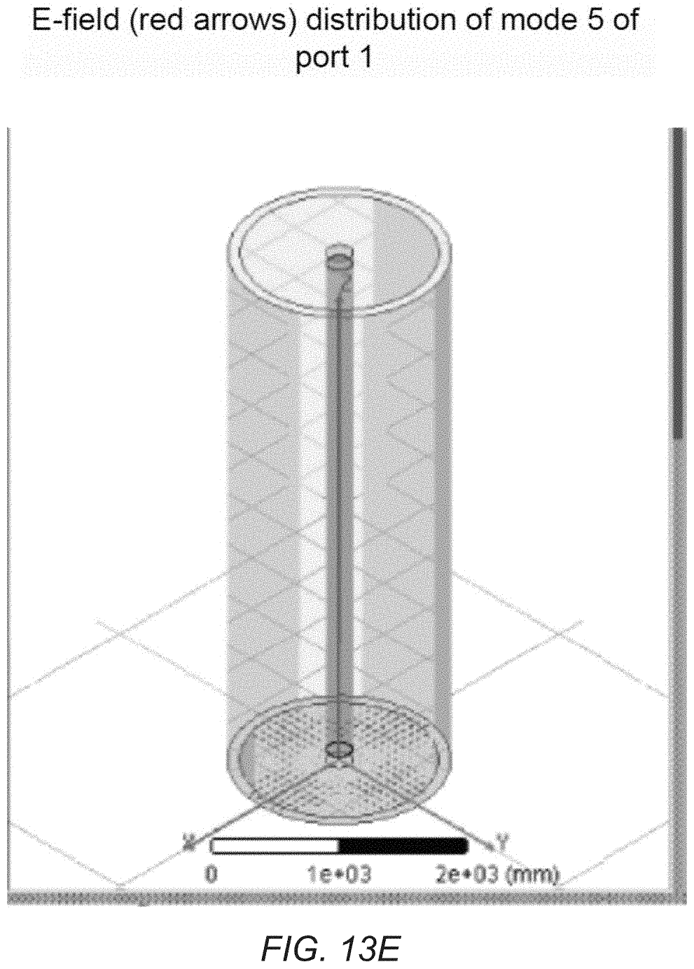

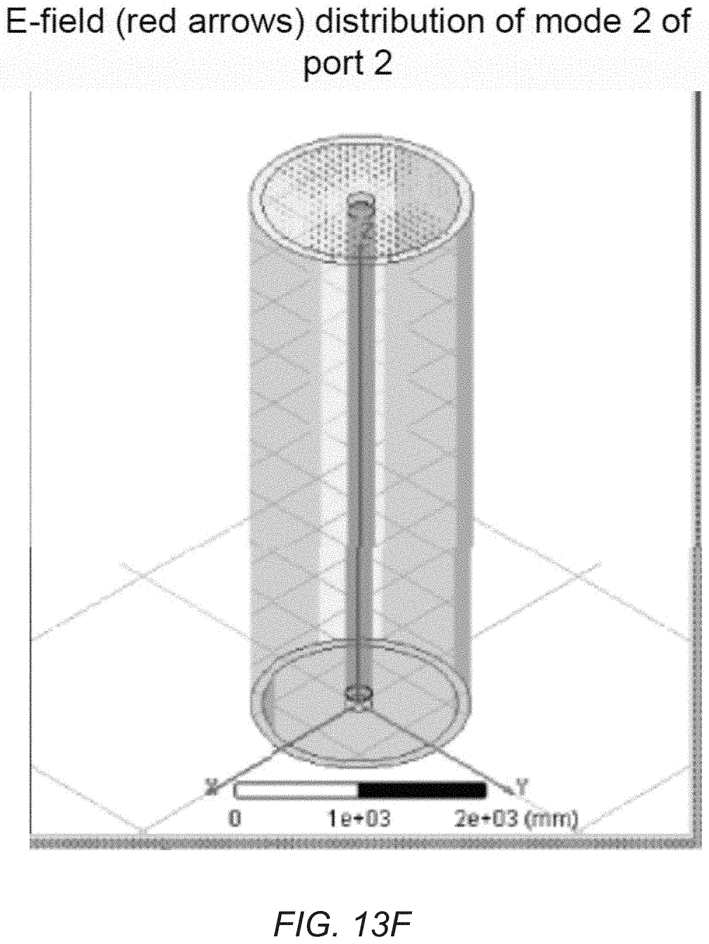

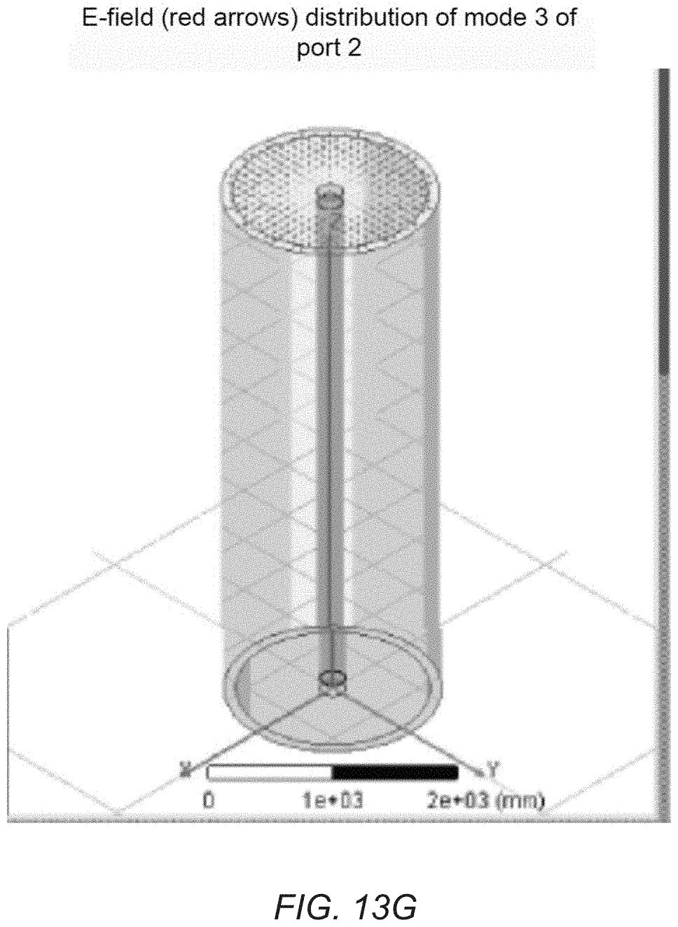

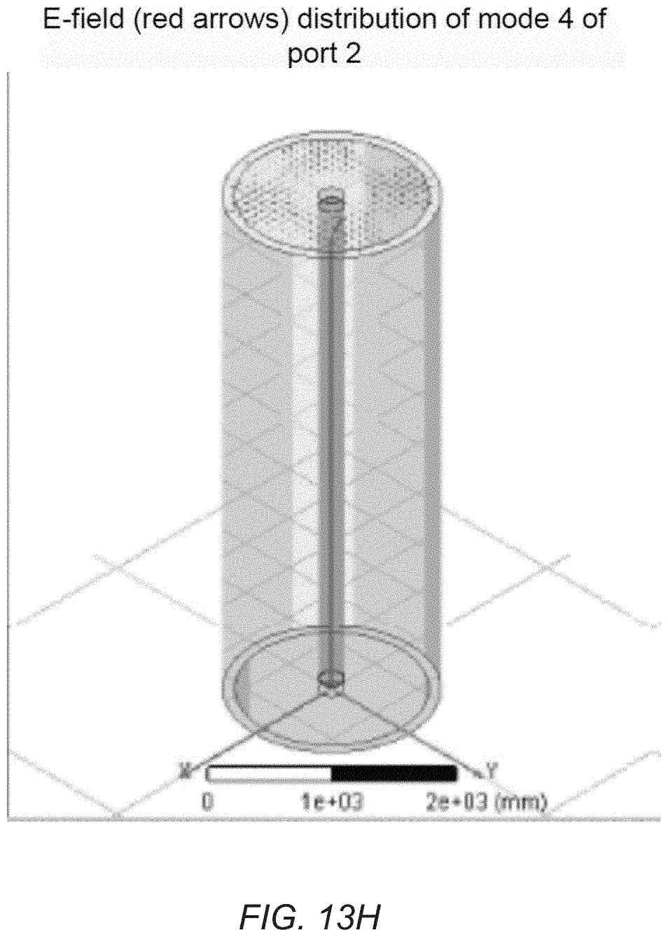

FIG. 13A to 13H illustrate the different electric field distributions for various different transmission modes and the coupling between the transmitter and the receiver for the different modes in accordance with an embodiment of the invention. The bottom circle corresponds to the transmission port (e.g., Port 1) and the top circle corresponds to the receiver port (e.g., Port 2). Each port can generate a different mode providing a different distribution of the electric field, illustrated in these figures by the vectors displayed in top or bottom circles. In many embodiments, the distributions of the electric fields can be orthogonal between the different modes. In order to have proper coupling, the mode that gets excited by port 1 should be the same mode that is captured by port 2 (the top circle). In particular, FIG. 13A is mode 1, port 1; FIG. 13B is mode 2, port 1, FIG. 13C is mode 3, port 1; FIG. 13D is mode 4, port 1; FIG. 13E is mode 5, port 1; FIG. 13F is mode 2, port 2; FIG. 13G is mode 3, port 2; and FIG. 13H is mode 4, port 2. Although FIG. 13A to FIG. 13H illustrate five different modes between two ports, any of a variety of transmission modes can be utilized as appropriate to the requirements of specific applications in accordance with embodiments of the invention.

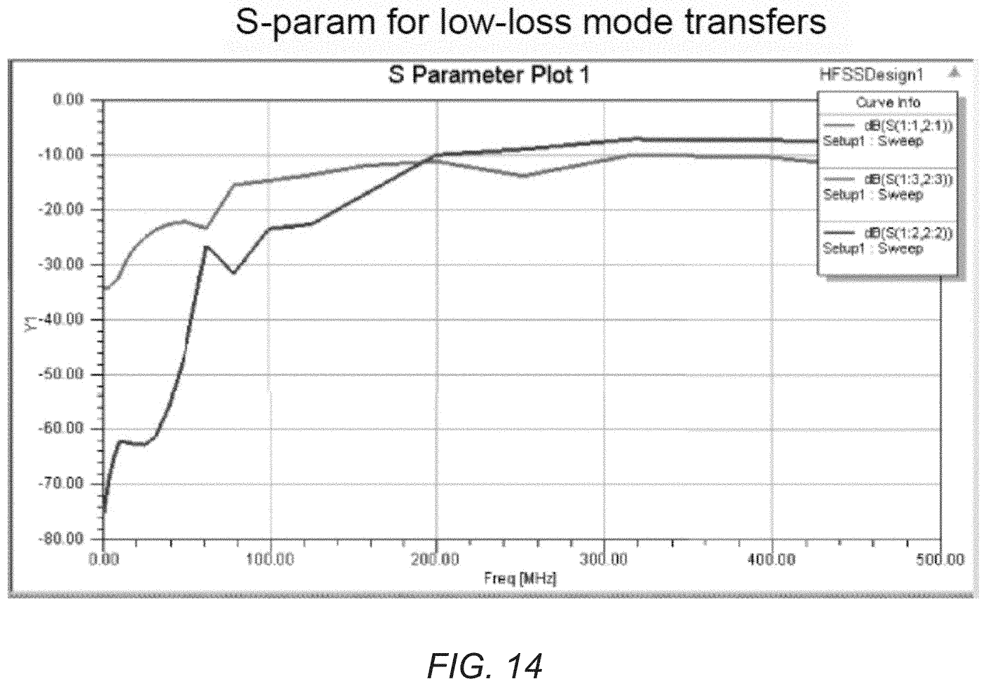

FIG. 14 illustrates a graph comparing the S-parameter for low-loss mode transfers in accordance with an embodiment of the invention. Each color corresponds to the coupling between the transmitter (e.g., Port 1) and receiver (e.g., Port 2) for a particular mode. In particular, the brown color corresponds to S(1:1, 2:1) illustrating the coupling between port 1 and port 2 for a mode 1 transmission mode. The blue color corresponds to S(1:2, 2, 2) corresponding to the coupling between port 1 and port 2 for a mode 2 transmission mode. As illustrated, both modes above a certain frequency (approximately 200 MHz) experience a similar coupling (e.g., approximately −10 dB). However, for lower frequencies, the brown mode provides a relatively low attenuation. For example, in oil or gas applications, the lower frequencies may be of interest as soil and other matter may absorb the higher frequencies. As illustrated, at frequencies less than approximately 50 MHz, the mode 1 transmission may have significantly less attenuation than the mode 2 transmission, but at higher frequencies the two modes are comparable.

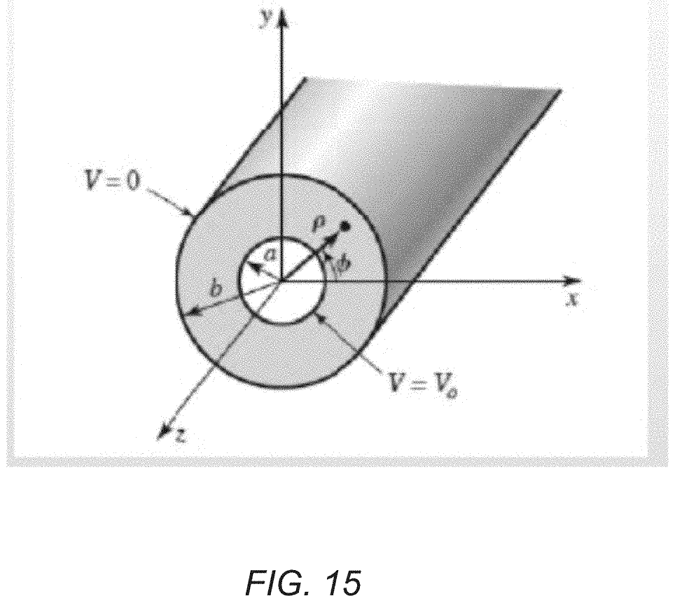

FIG. 15 illustrates a pipeline transmission line geometry, where b can be set to infinity in accordance with an embodiment of the invention. The particular computations for the TEM modes, TE mode, and TM mode can be found in “Microwave Engineering” by David M. Pozar, (herein referred to as Pozar) fourth edition, which is herein incorporated by reference in its entirety. In particular, Chapter 3, section 3.5 provides the relevant computations for the TEM and TE modes, including the following computations (note b=infinite):

$\frac{1}{ρ} \frac{\partial }{\partial ρ} ( ρ \frac{\partial Φ ( ρ , ϕ )}{\partial ρ} ) + \frac{1}{{ρ}^{2}} \frac{{\partial }^{2} Φ ( ρ , ϕ )}{\partial {ϕ}^{2}} = 0.$
This equation must be solved for Φ(ρ, ϕ) subject to the boundary
conditions
Φ(a, ϕ) = Vₒ,
Φ(b, ϕ) = 0.
Φ(ρ, ϕ) = R(ρ)P(ϕ).
Substituting (3.145) into (3.143) and dividing by RP gives
(3.146)
$\frac{ρ}{R} \frac{\partial }{\partial ρ} ( ρ \frac{dR}{d ρ} ) + \frac{1}{P} \frac{{d}^{2} P}{d {ϕ}^{2}} = 0.$
By the usual separation-of-variables argument, the two terms in (3.146)
must be equal to constants, so that
(3.147)
$\frac{ρ}{R} \frac{\partial }{\partial ρ} ( ρ \frac{dR}{d ρ} ) = - {k}_{ρ}^{2} ,$
(3.148)
$\frac{1}{P} \frac{{d}^{2} P}{d {ϕ}^{2}} = - {k}_{ϕ}^{2} ,$
(3.149)
k_{ρ}² + k_{ϕ}² = 0.
The general solution to (3.148) is
(3.150)
P(ϕ) = A cos nϕ + B sin nϕ,
where k_{ϕ} = n must be an integer since increasing ϕ by a multiple of 2π
should not change the result. Now, because the boundary conditions of
(3.144) do not vary with ϕ, the potential Φ(ρ, ϕ) should not vary with ϕ.
Thus, n must be zero. By (3.149), this implies that k_{ρ} must also be zero,
so that the equation for R(ρ) is (3.147) reduces to
$\frac{\partial }{\partial ρ} ( ρ \frac{dR}{d ρ} ) = 0.$
The solution for R(ρ) is then
R(ρ) = C ln ρ + D,
and so
(3.151)
Φ(ρ, ϕ) = C ln ρ + D.
Applying the boundary conditions of (3.144) gives two equations for the
constants C and D:
(3.152a)
Φ(a, ϕ) = Vₒ = C ln a + D,
(3.152b)
Φ(b, ϕ) = 0 = C ln b + D.
After solving for C and D, we can write the final solution for Φ(ρ, ϕ) as
(3.153)
$Φ ( ρ , ϕ ) = \frac{{V}_{o} ln b / ρ}{ln b / a} .$

With respect to the TE mode, the following computations can be used from Pozar:

$$( \frac{{\partial }^{2}}{\partial {ρ}^{2}} + \frac{1}{ρ} \frac{\partial }{\partial ρ} + \frac{1}{{ρ}^{2}} \frac{{\partial }^{2}}{\partial {ϕ}^{2}} + {k}_{c}^{2} ) {h}_{z} ( ρ , ϕ ) = 0 ,$$

$$where {H}_{z} ( ρ , ϕ , z ) = {h}_{z} ( ρ , ϕ ) {e}^{- j β z} , and {k}_{c}^{2} = {k}^{2} - {β}^{2} .$$

$${h}_{z} ( ρ , ϕ ) = ( A sin n ϕ + B cos n ϕ ) ( {CJ}_{n} ( {k}_{c} ρ ) + {DY}_{n} ( {k}_{c} ρ ) ) .$$

$${E}_{ϕ} ( ρ , ϕ , z ) = 0 for ρ = a , b .$$

$${E}_{ϕ} = \frac{j ω μ}{{k}_{c}} ( A sin n ϕ + B cos n ϕ ) [ {CJ}_{n}^{′} ( {k}_{c} ρ ) + {DY}_{n}^{′} ( {k}_{c} ρ ) ] {e}^{- j β z} .$$

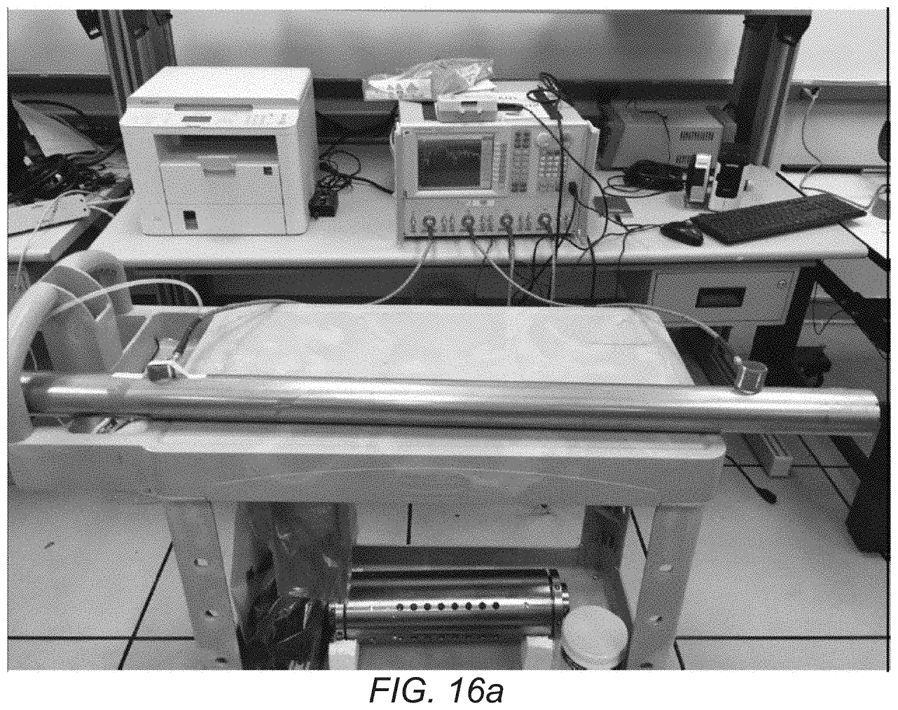

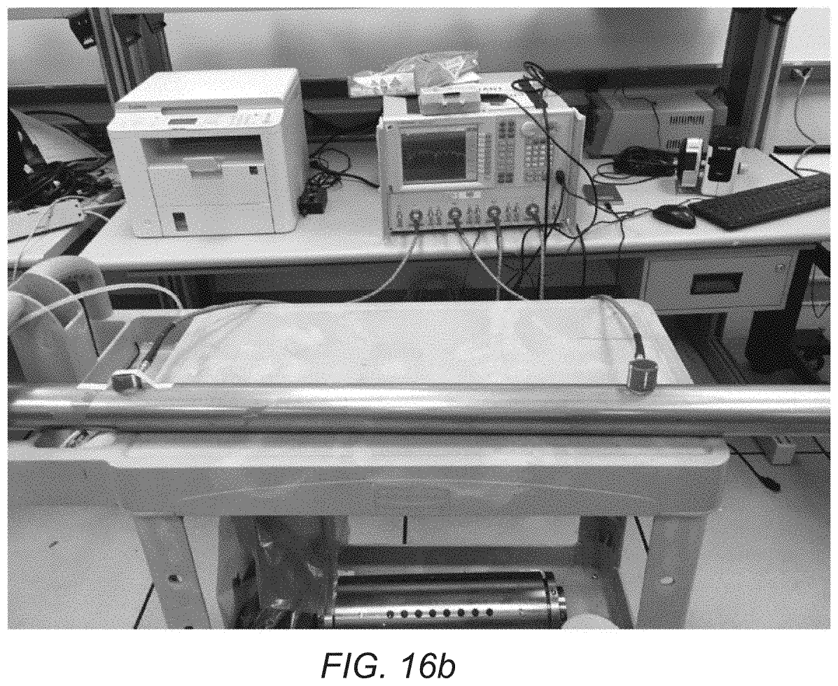

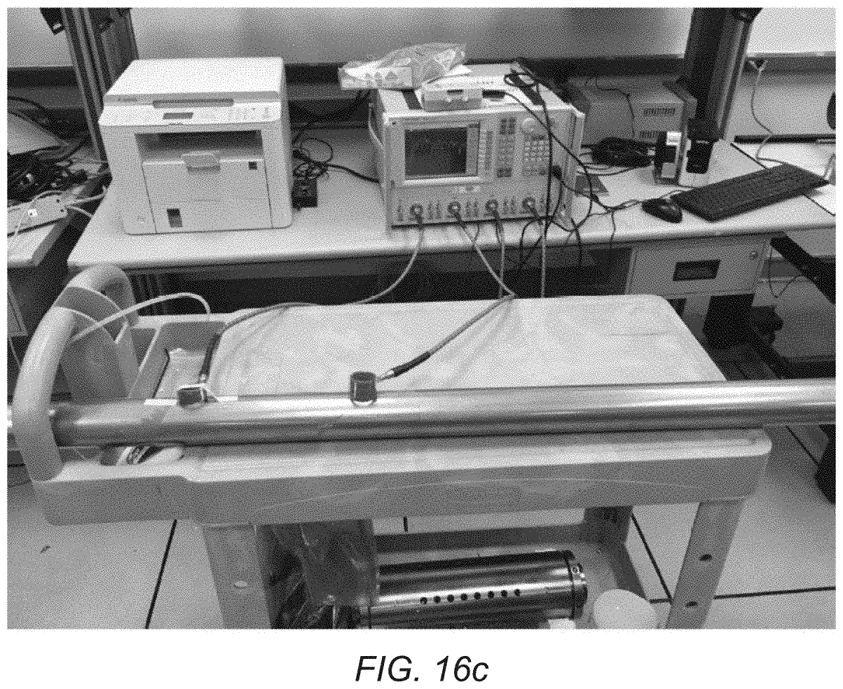

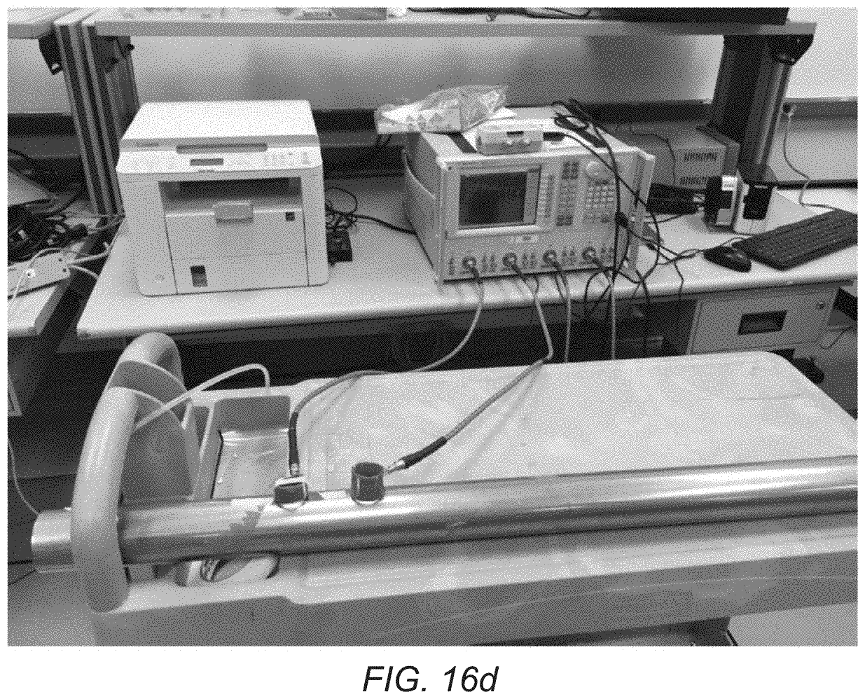

FIG. 16a-16d illustrate an experimental setup for analyzing a cylindrical surface waveguide in accordance with an embodiment of the invention. In particular, a transmitter and a receiver can be positioned along the outside surface of the cylindrical pipe. A network analyzer can be used to analyze the characteristics of the waves being transmitted along the surface. FIGS. 16b, 16c and 16d illustrate positioning the transmitter and receiver at different distances apart in order to analyze the effects of distance on the measurements. Although FIG. 16a-16d illustrate a particular experimental setup for analyzing the cylindrical waveguide, any of a variety of experimental configurations can be utilized as appropriate to the requirements of specific applications in accordance with embodiments of the invention.

Although specific methods and systems for guided-wave powered wireless sensors are discussed above, many different systems can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A system, comprising:
a cylindrical shape;
an electromagnetic transmitter positioned along the cylindrical shape and configured to transmit electromagnetic waves to at least one wirelessly powered sensor positioned along the cylindrical shape, wherein the cylindrical shape is used as a waveguide to transmit the electromagnetic waves using a particular waveguide mode;
wherein the at least one wirelessly powered sensor is configured to be operated without a battery and to be powered by the electromagnetic waves emitted by the electromagnetic transmitter;
wherein the at least one wirelessly powered sensor senses at least one characteristic related to the cylindrical shape.

2. The system of claim 1, wherein the electromagnetic transmitter transmits the electromagnetic waves along an outer surface of the cylindrical shape to the at least one wirelessly powered sensor.

3. The system of claim 1, wherein the electromagnetic transmitter transmits the electromagnetic waves along an inner surface of the cylindrical shape to the at least one wirelessly powered sensor.

4. The system of claim 1, wherein the electromagnetic transmitter transmits the electromagnetic waves using a mode selected from the group consisting of a transverse electromagnetic mode (TEM), a transverse magnetic mode (TM), and a transverse electric mode (TE).

5. The system of claim 1, wherein the cylindrical shape is a pipeline used to transport a natural resource including at least one of a fluid and a gas.

6. The system of claim 4, wherein the fluid comprises a hydrocarbon liquid.

7. The system of claim 1, wherein the cylindrical shape is used as a circular waveguide.

8. The system of claim 1, further comprising a controller configured to communicate with the at least one wirelessly powered sensor.

9. The system of claim 7, wherein the at least one wirelessly powered sensor transmits data to the controller using the surface of the cylindrical shape as a waveguide.

10. The system of claim 1, wherein the cylindrical shape is a pipeline buried beneath the earth's surface.

11. The system of claim 1, wherein the at least one wirelessly powered sensor comprises a plurality of wirelessly powered sensors embedded at different locations along the cylindrical shape.

12. The system of claim 1, wherein the cylindrical shape is a pipeline and the at least one wirelessly powered sensor is used to monitor at least one characteristic selected from the group consisting of an integrity of the pipeline, detection of corrosion and cracks along the pipeline, detection of changes in pH, detection of leaks, and detection of gases.

13. The system of claim 1, wherein the system is further configured to provide a notification upon detection of a particular event related to the cylindrical shape based on data from the at least one wirelessly powered sensor.

14. The system of claim 1, wherein the at least one wirelessly powered sensor is a wireless sensor that is capable of measuring at least one state of the cylindrical shape selected from the group consisting of a temperature, a flow rate, and a pressure.

15. A method of transmitting power using a circular waveguide, comprising:
transmitting, using an electromagnetic transmitter positioned along a cylindrical shape, electromagnetic waves to at least one wirelessly powered sensor positioned along the cylindrical shape, wherein the cylindrical shape is used as a waveguide to transmit the electromagnetic waves using a particular waveguide mode form of electromagnetic radiation; wherein the at least one wirelessly powered sensor is configured to be operated without a battery and to be powered by the electromagnetic waves emitted by the electromagnetic transmitter; and
sensing, using the at least one wirelessly powered sensor, at least one characteristic related to the cylindrical shape.

16. The method of claim 15, wherein the electromagnetic waves are transmitted along an outer surface of the cylindrical shape to the at least one wirelessly powered sensor.

17. The method of claim 15, wherein the electromagnetic waves are transmitted along an inner surface of the cylindrical shape to the at least one wirelessly powered sensor.

18. The method of claim 15, wherein the electromagnetic waves are transmitted using a mode selected from the group consisting of a transverse electromagnetic mode (TEM), a transverse magnetic mode (TM), and a transverse electric mode (TE).

19. The method of claim 15, wherein the cylindrical shape is a pipeline used to transport a natural resource including at least one of a fluid and a gas.

20. The method of claim 15, further comprising providing a notification upon detecting a particular event related to the cylindrical shape based on data from the at least one wirelessly powered sensor.
